(19) United States
(12) Patent Application Publication
(10) Pub. No.: US 2026/0124739 A1
(43) Pub. Date: May 7, 2026

(54) MECHANIC'S CREEPER

(71) Applicant: LIH YANN INDUSTRIAL CO., LTD., Taichung City (TW)

(72) Inventor: Po-Lin LIAO, Taichung City (TW)

(21) Appl. No.: 19/366,936

(22) Filed: Oct. 23, 2025

(30) Foreign Application Priority Data
Nov. 6, 2024 (TW) 113142597

(51) Int. Cl. B25H 5/00

(52) U.S. Cl. CPC B25H 5/00

(57) ABSTRACT

A mechanic’s creeper comprises a main body, at least one first wheel assembly and at least one second wheel assembly. The main body includes a first component and a second component, and the first component is telescopically connected with the second component. The at least one first wheel assembly is disposed on the first component, and the at least one second wheel assembly is disposed on the second component.

### BACKGROUND OF THE INVENTION

### Field of the Invention

The present invention relates to a mechanic’s creeper.

### Description of the Prior Art

There are numerous wiring layouts on the underside of a vehicle. In the absence of a car lift, a car mechanic often uses a creeper to freely and quickly slide between the ground and the underside of the vehicle, so as to facilitate inspection, repair, or maintenance operations such as inspecting the exhaust system, repairing the transmission, or replacing the oil filter. Examples of such mechanic’s creepers are disclosed in Taiwan Patents M598769, M594528, M591906, and M525827.

However, the mechanic’s creepers disclosed in the above patents cannot be adjusted according to the body shape of the car mechanic, resulting in poor user experience and physical discomfort during use.

The present invention is, therefore, arisen to obviate or at least mitigate the above-mentioned disadvantages.

### SUMMARY OF THE INVENTION

The main object of the present invention is to provide a mechanic’s creeper, which is adjustable according to a user’s height, ensuring stable support.

To achieve the above and other objects, the present invention provides a mechanic’s creeper, comprising: a main body, at least one first wheel assembly and at least one second wheel assembly. The main body includes a first component and a second component, and the first component is telescopically connected with the second component. The at least one first wheel assembly is disposed on the first component, and the at least one second wheel assembly is disposed on the second component.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of FIG. 1;

FIG. 3 is a breakdown drawing of FIG. 1 as viewed from a perspective different from that of FIG. 2;

FIG. 4 is a bottom view of FIG. 1;

FIG. 5 is a bottom view showing relative movement of a first component and a second component according to a preferable embodiment of the present invention;

FIG. 6 is a stereogram showing relative movement of the first component and the second component according to a preferable embodiment of the present invention;

FIG. 7 is a partial cross-sectional view showing insertion of a first connecting member into the first component and the second component according to a preferable embodiment of the present invention;

FIG. 8 is a cross-sectional view as viewed in a telescopic direction according to a preferable embodiment of the present invention;

FIG. 9 is a drawing showing an original position of a headrest portion according to a preferable embodiment of the present invention; and

FIG. 10 is a drawing showing a movement of the headrest portion when being pressed according to a preferable embodiment of the present invention.

### DETAILED DESCRIPTION OF THE PREFERRED EMBODIMENTS

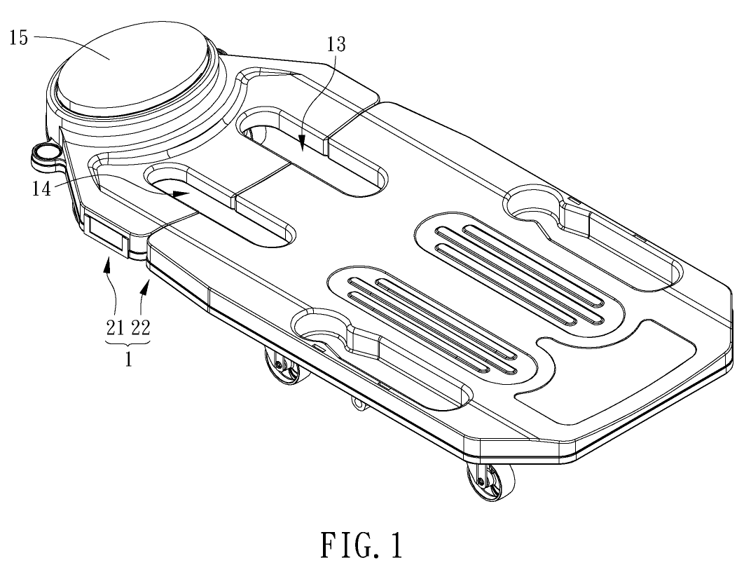

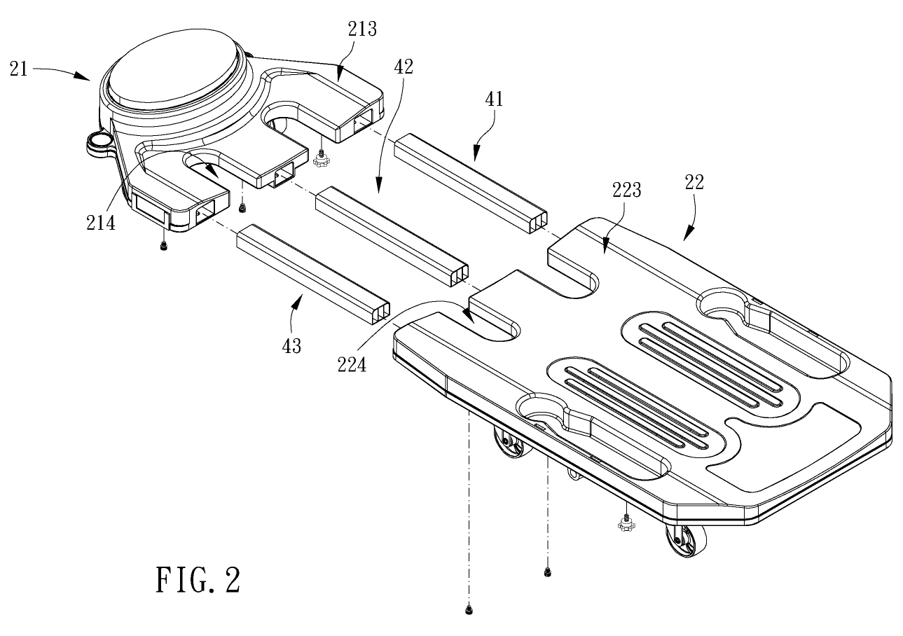

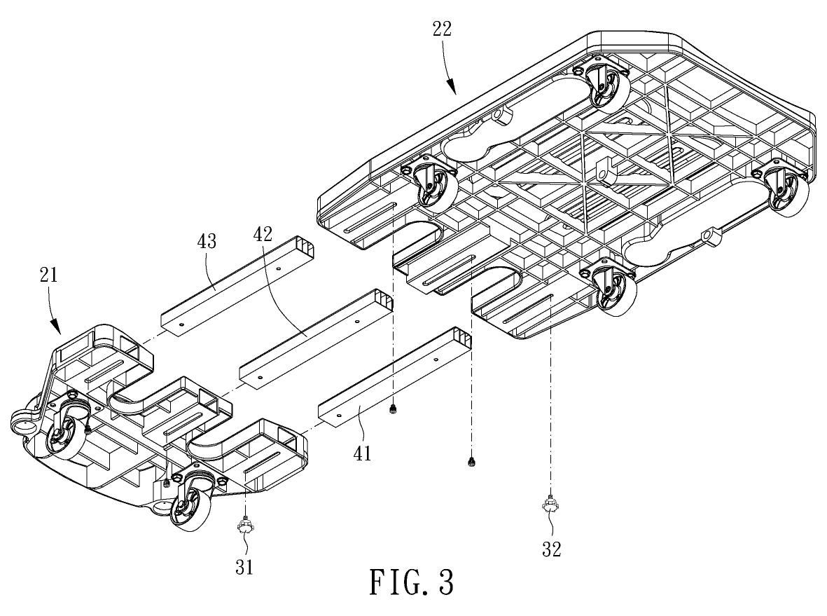

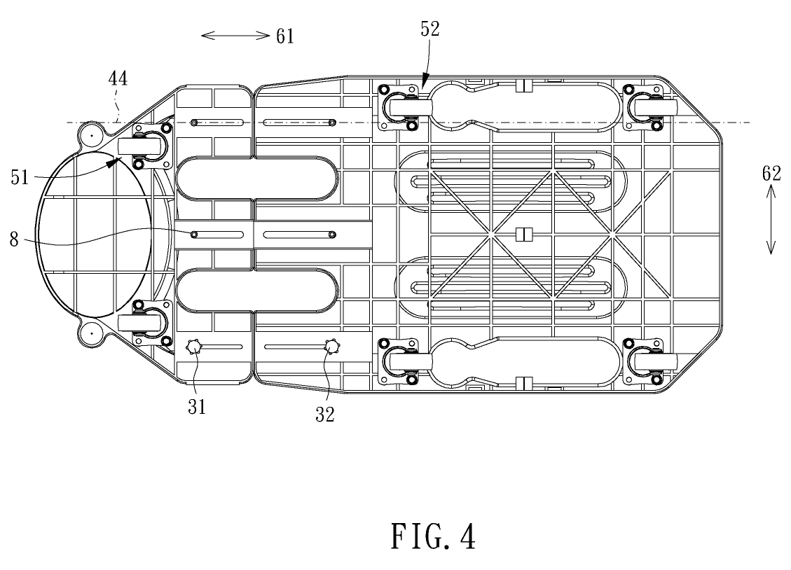

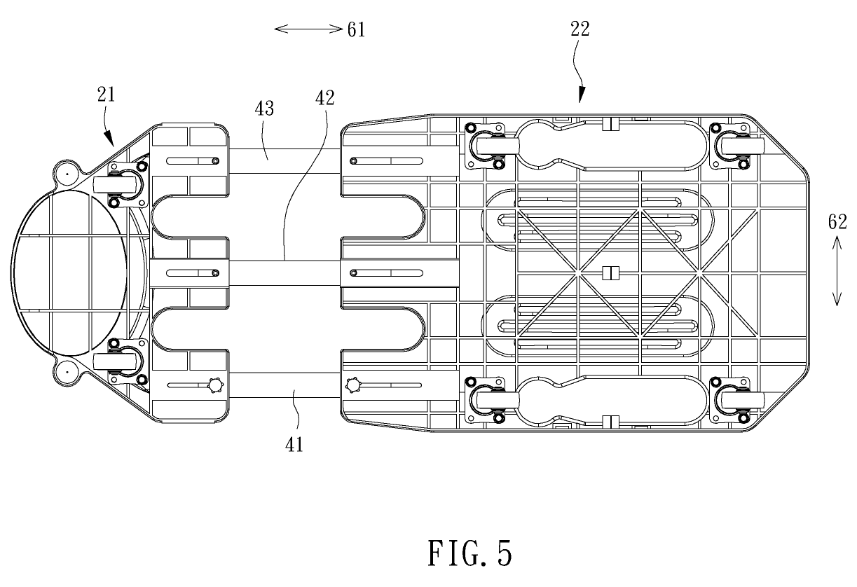

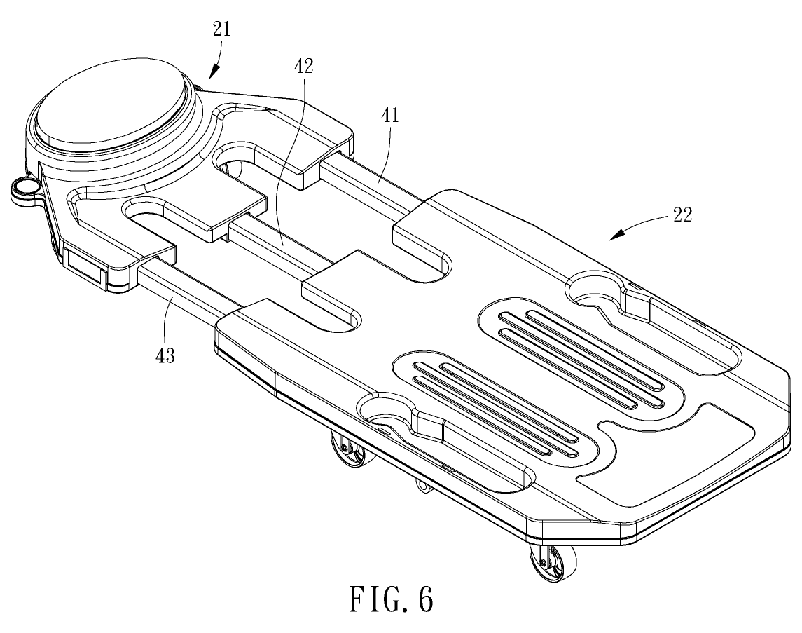

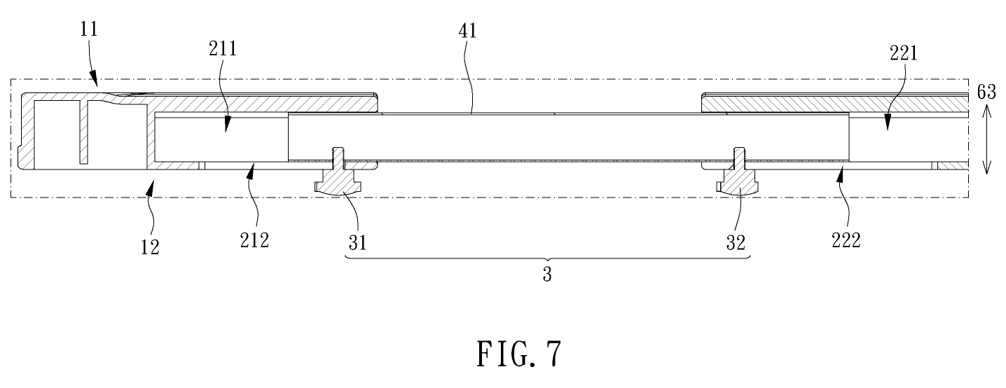

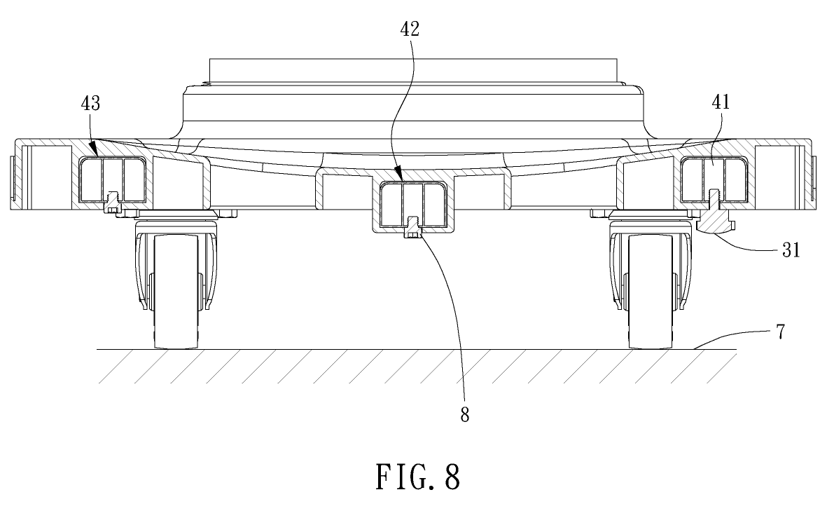

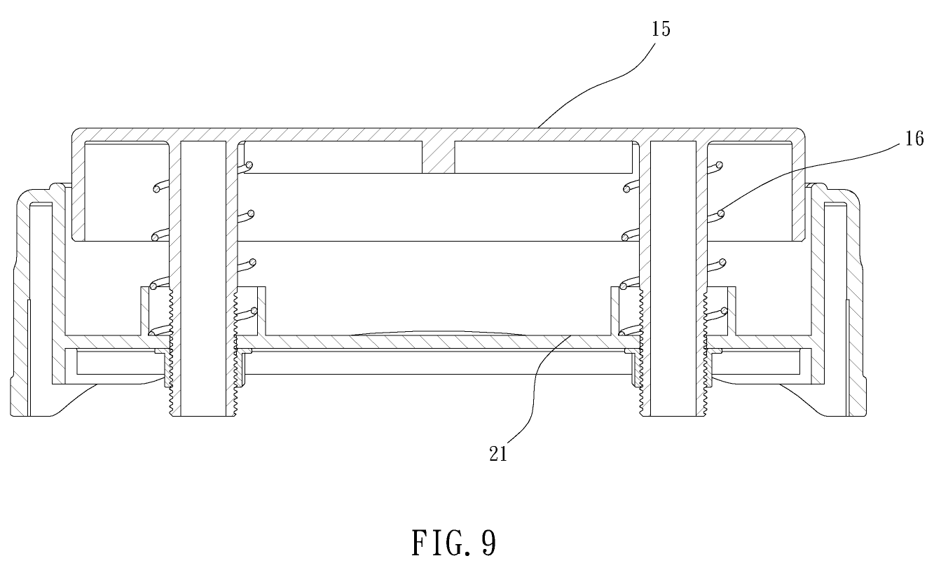

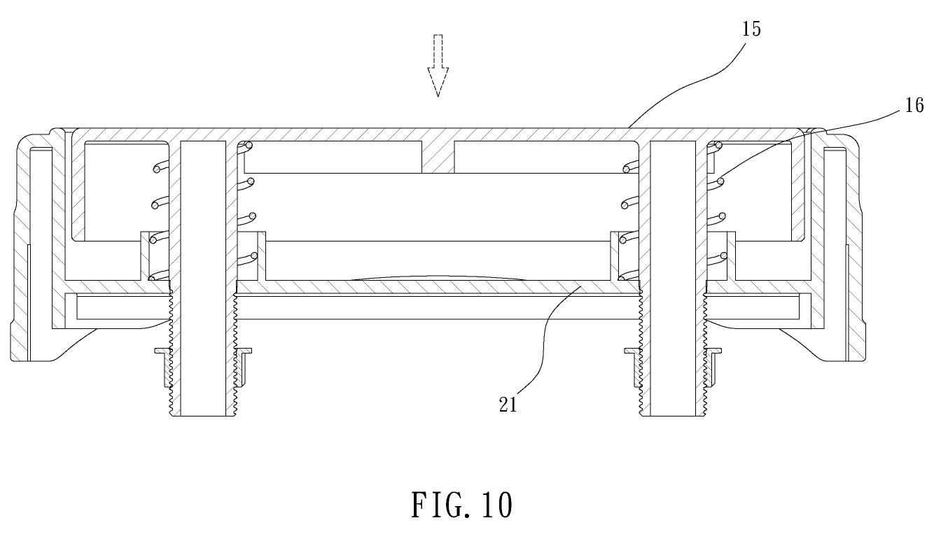

Please refer to FIGS. 1 to 10 for a preferable embodiment of the present invention. A mechanic’s creeper of the present invention comprises a main body 1, at least one first wheel assembly 51 and at least one second wheel assembly 52.

The main body 1 includes a first component 21 and a second component 22, and the first component 21 is telescopically connected with the second component 22. The main body 1 further includes a headrest portion 15 and at least one elastic member 16, the headrest portion 15 is disposed on the first component 21 and is configured to support a user’s head, and the at least one elastic member 16 is elastically abutted against and between the headrest portion 15 and the first component 21 so that the headrest portion 15 has a tendency to move in a direction away from the first component 21. The at least one elastic member 16 can further provide supporting force to the headrest portion 15, so that the headrest portion 15 can be adjusted to different heights in accordance with the weight of the user’s head. The at least one elastic member 16 can also buffer the downward moving speed and impact of the headrest portion 15 caused by the weight of the user’s head, thereby achieving the purpose of protecting the user’s head when lying down. The at least one first wheel assembly 51 is disposed on the first component 21, and the at least one second wheel assembly 52 is disposed on the second component 22, so that the at least one first wheel assembly 51 and the at least one second wheel assembly 52 can respectively provide supporting force to the first component 21 and the second component 22.

The main body 1 further includes at least one connecting member, and at least one of the first component 21 and the second component 22 is movably connected with the at least one connecting member. During use, the user may move the first component 21 or the second component 22 as needed to adjust an overall length of the main body 1.

Specifically, the main body 1 further includes a first side portion 11 and a second side portion 12 opposite to each other in a thickness direction 63 of the main body 1, the first side portion 11 is configured to support a human body, and the second side portion 12 has the at least one first wheel assembly 51 and the at least one second wheel assembly 52 disposed thereon. The at least one first wheel assembly 51, the at least one second wheel assembly 52 and the at least one connecting member are non-overlapped with one another in the thickness direction 63, so as to ensure that the main body 1 has sufficient structural strength in the thickness direction 63.

Moreover, each of the at least one connecting member extends straightly and defines a central axis 44, and at least one of the at least one first wheel assembly 51 and at least one of the at least one second wheel assembly 52 are located at two opposite sides of the central axis 44 of adjacent one of said connecting member. When the at least one connecting member bears a load, the load can be effectively dispersed to the at least one first wheel assembly 51 and the at least one second wheel assembly 52 located at the two opposite sides. As viewed in an extending direction of the central axis 44 of one of the at least one the connecting member, at least one of the at least one first wheel assembly 51 and at least one of the at least one second wheel assembly 52 are respectively and at least partially overlapped with said connecting member, so as to effectively provide support along the extending direction.

In this embodiment, the main body 1 includes a plurality of said connecting members, two end portions of each of the plurality of said connecting members are movably assembled with the first component 21 and the second component 22, and the first component 21 and the second component 22 are telescopically movable relative to each other in a telescopic direction 61. The first component 21 includes a plurality of first insertion grooves 211 and a plurality of first sliding grooves 212, and the plurality of first sliding grooves 212 are respectively communicated with the plurality of first insertion grooves 211. The second component 22 includes a plurality of second insertion grooves 221 and a plurality of second sliding grooves 222, and the plurality of second sliding grooves 222 are respectively communicated with the plurality of second insertion grooves 221. Two end portions of each of the plurality of said connecting members are movably disposed into one of the plurality of first insertion grooves 211 and one of the plurality of second insertion grooves 221. In the telescopic direction 61, a length of the second component 22 is longer than a length of the first component 21, and a length of each of the plurality of second insertion grooves 221 is longer than a length of each of the plurality of first insertion grooves 211.

The plurality of said connecting members are spacedly arranged in an arrangement direction 62 and respectively inserted into the first component 21 and the second component 22. The main body 1 further includes at least one positioning assembly 3, and the at least one positioning assembly 3 includes a first positioning member 31 and a second positioning member 32. The first positioning member 31 penetrates through the first component 21 and is connected with one of the plurality of said connecting members, and the second positioning member 32 penetrates through the second component 22 and is connected with one of the plurality of said connecting members. In this embodiment, a side of the first component 21 forms a plurality of first convex portions 213 and plurality of first concave portions 214 which are alternatively arranged in a direction vertical to the telescopic direction 61, and a side of the second component 22 forms a plurality of second convex portions 223 and a plurality of second concave portions 224 which are alternatively arranged in the direction vertical to the telescopic direction 61. The plurality of first concave portions 214 and the plurality of second concave portions 224 are communicated with each other in the telescopic direction 61 and define a first through hole 13 and a second through hole 14 therebetween. The plurality of said connecting members are respectively connected with the plurality of first convex portions 213 and the plurality of second convex portions 223. The plurality of said connecting members includes a first connecting member 41, a second connecting member 42 and a third connecting member 43, and the main body 1 includes one said positioning assembly 3. The first positioning member 31 and the second positioning member 32 respectively penetrate through one of the plurality of first sliding grooves 212 and one of the plurality of second sliding grooves 222 and are connected with the first connecting member 41.

Preferably, the main body 1 further includes a plurality of insertion members 8, and the plurality of the insertion members 8 respectively penetrate through one of the plurality of first sliding grooves 212 and one of the plurality of second sliding grooves 222 and are connected with the second connecting member 42 and the third connecting member 43 to prevent detachment.

The mechanic’s creeper comprises a plurality of said first wheel assemblies 51 and a plurality of said second wheel assemblies 52 so that supporting force can be provided at various positions. A number of the plurality of said second wheel assemblies 52 is different from a number of the plurality of said first wheel assemblies 51.

In this embodiment, the number of the plurality of said first wheel assemblies 51 is 2, the number of the plurality of said second wheel assemblies 52 is 4, and the plurality of said first wheel assemblies 51 are identical to the plurality of said second wheel assemblies 52 in shape and size. The telescopic direction 61 is vertical to the arrangement direction 62, and a center point of each of the plurality of said first wheel assemblies 51 is offset relative to a center point of each of the plurality of said second wheel assemblies 52 in the telescopic direction 61. The plurality of said second wheel assemblies 52 are arranged at two opposite sides of the plurality of said first wheel assemblies 51 in the direction vertical to the telescopic direction 61.

Furthermore, based on a horizontal plane 7 supporting the plurality of said first wheel assemblies 51, in the thickness direction 63, the second connecting member 42 is lower than the first connecting member 41 and the third connecting member 43, and the first connecting member 41 and the third connecting member 43 are positioned at the same elevation. The second connecting member 42 mainly provides a forward supporting force to the human body, while the first connecting member 41 and the third connecting member 43 simultaneously provide both lateral and forward supporting forces to the human body.

As viewed in an extending direction of the first connecting member 41, one of the plurality of said first wheel assemblies 51 is overlapped with two of the plurality of said second wheel assemblies 52; as viewed in in an extending direction of the third connecting member 43, one of the plurality of said first wheel assemblies 51 is overlapped with two of the plurality of said second wheel assemblies 52. the plurality of said first wheel assemblies 51 and the plurality of said second wheel assemblies 52 are located outside an extending direction of the second connecting member 42, thereby achieving the advantages as described above.

Preferably, the first through hole 13 is arranged between the first connecting member 41 and the second connecting member 42, and the second through hole 14 is arranged between the second connecting member 42 and the third connecting member 43. The first through hole 13 and the second through hole 14 can not only reduce an overall weight of the main body 1, but also provide ventilation and breathability benefits.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A mechanic’s creeper, comprising:
a main body, including a first component and a second component, the first component being telescopically connected with the second component;
at least one first wheel assembly, disposed on the first component; and
at least one second wheel assembly, disposed on the second component.

2. The mechanic’s creeper of claim 1, comprising a plurality of said first wheel assemblies and a plurality of said second wheel assemblies, wherein a number of the plurality of said second wheel assemblies is different from a number of the plurality of said first wheel assemblies.

3. The mechanic’s creeper of claim 1, comprising a plurality of said first wheel assemblies and a plurality of said second wheel assemblies, wherein the first component and the second component are telescopically movable relative to each other in a telescopic direction, and a center point of each of the plurality of said first wheel assemblies is offset relative to a center point of each of the plurality of said second wheel assemblies in the telescopic direction.

4. The mechanic’s creeper of claim 3, wherein the plurality of said second wheel assemblies are arranged at two opposite sides of the plurality of said first wheel assemblies in a direction vertical to the telescopic direction.

5. The mechanic’s creeper of claim 1, wherein the main body further includes a headrest portion and at least one elastic member, the headrest portion is configured to support a user’s head, the at least one elastic member is elastically abutted against and between the headrest portion and the first component so that the headrest portion has a tendency to move in a direction away from the first component.

6. The mechanic’s creeper of claim 1, wherein the main body further includes at least one connecting member, at least one of the first component and the second component is movably connected with the at least one connecting member.

7. The mechanic’s creeper of claim 6, wherein each of the at least one connecting member extends straightly and defines a central axis, at least one of the at least one first wheel assembly and at least one of the at least one second wheel assembly are located at two opposite sides of the central axis of adjacent one of said connecting member, as viewed in an extending direction of the central axis of one of the at least one connecting member, at least one of the at least one first wheel assembly and at least one of the at least one second wheel assembly are respectively and at least partially overlapped with said connecting member.

8. The mechanic’s creeper of claim 6, wherein the main body further includes a first side portion and a second side portion opposite to each other in a thickness direction of the main body, the first side portion is configured to support a human body, the second side portion has the at least one first wheel assembly and the at least one second wheel assembly disposed thereon; and the at least one first wheel assembly, the at least one second wheel assembly and the at least one connecting member are non-overlapped with one another in the thickness direction.

9. The mechanic’s creeper of claim 6, wherein the main body includes a plurality of said connecting members, two end portions of each of the plurality of said connecting members are movably assembled with the first component and the second component.

10. The mechanic’s creeper of claim 9, wherein the plurality of said connecting members are spacedly arranged in an arrangement direction and respectively inserted into the first component and the second component, the main body further includes at least one positioning assembly, the at least one positioning assembly includes a first positioning member and a second positioning member, the first positioning member penetrates through the first component and is connected with one of the plurality of said connecting members, and the second positioning member penetrates through the second component and is connected with one of the plurality of said connecting members.

11. The mechanic’s creeper of claim 2, wherein the first component and the second component are telescopically movable relative to each other in a telescopic direction, and a center point of each of the plurality of said first wheel assemblies is offset relative to a center point of each of the plurality of said second wheel assemblies in the telescopic direction; the plurality of said second wheel assemblies are arranged at two opposite sides of the plurality of said first wheel assemblies in a direction vertical to the telescopic direction; the main body further includes at least one connecting member, at least one of the first component and the second component is movably connected with the at least one connecting member; each of the at least one connecting member extends straightly and defines a central axis, at least one of the at least one first wheel assembly and at least one of the at least one second wheel assembly are located at two opposite sides of the central axis of adjacent one of said connecting member, as viewed in an extending direction of the central axis of one of the at least one connecting member, at least one of the at least one first wheel assembly and at least one of the at least one second wheel assembly are respectively and at least partially overlapped with said connecting member; the main body further includes a first side portion and a second side portion opposite to each other in a thickness direction of the main body, the first side portion is configured to support a human body, the second side portion has the at least one first wheel assembly and the at least one second wheel assembly disposed thereon; and the at least one first wheel assembly, the at least one second wheel assembly and the at least one connecting member are non-overlapped with one another in the thickness direction; the main body includes a plurality of said connecting members, two end portions of each of the plurality of said connecting members are movably assembled with the first component and the second component; the plurality of said connecting members are spacedly arranged in an arrangement direction and respectively inserted into the first component and the second component, a side of the first component forms a plurality of first convex portions and plurality of first concave portions which are alternatively arranged in a direction vertical to the telescopic direction, a side of the second component forms a plurality of second convex portions and a plurality of second concave portions which are alternatively arranged in the direction vertical to the telescopic direction, the plurality of the first concave portions and the plurality of the second concave portions are communicated with each other in the telescopic direction and define a first through hole and a second through hole therebetween, the plurality of said connecting members are respectively connected with the plurality of first convex portions and the plurality of second convex portions; the main body further includes at least one positioning assembly, the at least one positioning assembly includes a first positioning member and a second positioning member, the first positioning member penetrates through the first component and is connected with one of the plurality of said connecting members, and the second positioning member penetrates through the second component and is connected with one of the plurality of said connecting members; the plurality of said first wheel assemblies are identical to the plurality of said second wheel assemblies in shape and size; the main body includes one said positioning assembly, the main body further includes a plurality of insertion members, the first component includes a plurality of first insertion grooves and a plurality of first sliding grooves, the plurality of first sliding grooves are respectively communicated with the plurality of first insertion grooves, the second component includes a plurality of second insertion grooves and a plurality of second sliding grooves, the plurality of second sliding grooves are respectively communicated with the plurality of second insertion grooves, two end portions of each of the plurality of said connecting members are movably disposed into one of the plurality of first insertion grooves and one of the plurality of second insertion grooves, in the telescopic direction, a length of the second component is longer than a length of the first component, and a length of each of the plurality of second insertion grooves is longer than a length of each of the plurality of first insertion grooves, the plurality of said connecting members include a first connecting member, a second connecting member and a third connecting member, the first positioning member and the second positioning member respectively penetrate through one of the plurality of first sliding grooves and one of the plurality of second sliding grooves and are connected with the first connecting member, the plurality of insertion members respectively penetrate through one of the plurality of first sliding grooves and one of the plurality of second sliding grooves and are connected with the second connecting member and the third connecting member; as viewed in an extending direction of the first connecting member, one of the plurality of said first wheel assemblies is overlapped with two of the plurality of said second wheel assemblies, as viewed in an extending direction of the third connecting member, one of the plurality of said first wheel assemblies is overlapped with two of the plurality of said second wheel assemblies, the plurality of said first wheel assemblies and the plurality of said second wheel assemblies are located outside an extending direction of the second connecting member; the first through hole is arranged between the first connecting member and the second connecting member, the second through hole is arranged between the second connecting member and the third connecting member; the main body further includes a headrest portion and at least one elastic member, the headrest portion is configured to support an user’s head, the at least one elastic member is elastically abutted against and between the headrest portion and the first component so that the headrest portion has a tendency to move in a direction away from the first component; and based on a horizontal plane supporting the plurality of said first wheel assemblies, in the thickness direction, the second connecting member is lower than the first connecting member and the third connecting member, and the first connecting member and the third connecting member are positioned at the same elevation.
